(19) United States
(12) Patent Application Publication
(10) Pub. No.: US 2015/0142874 A1
(43) Pub. Date: May 21, 2015

(54) PRIORITIZED ONE-SHOT BROWSING TO REDUCE HTTP PAGE DOWNLOAD DELAY

(71) Applicant: QUALCOMM Incorporated, San Diego, CA (US)

(72) Inventors: Linhai HE, San Diego, CA (US); Rohit KAPOOR, San Diego, CA (US); Rashid Ahmed Akbar ATTAR, San Diego, CA (US)

(21) Appl. No.: 14/460,146

(22) Filed: Aug. 14, 2014

Related U.S. Application Data
(60) Provisional application No. 61/905,718, filed on Nov. 18, 2013.

(51) Int. Cl. H04L 29/08

(52) U.S. Cl. CPC H04L 67/02; H04L 67/28
USPC 709/203

(57) ABSTRACT

Methods and apparatus are described for reducing round-trip time (RRT) for communications between a proxy and a browser. The methods and apparatus may include receiving a webpage from a server in response to forwarding to the server a first request received from the browser. Further, the methods and apparatus may include parsing the webpage for one or more object identifiers. Moreover, the methods and apparatus may include requesting one or more objects from the server based on the one or more object identifiers. Additionally the methods and apparatus may include storing the one or more objects received from the server.

### CLAIM OF PRIORITY UNDER 35 U.S.C. §119

The present Application for Patent claims priority to U.S. Provisional Application No. 61/905,718 entitled “PRIORITIZED ONE-SHOT BROWSING TO REDUCE HTTP PAGE DOWNLOAD DELAY” filed Nov. 18, 2013, Qualcomm Ref. No. 140857P1, assigned to the assignee hereof and hereby expressly incorporated by reference.

### BACKGROUND

Aspects of the present disclosure relate generally to telecommunication systems, and more particularly, to an apparatus and method for a telecommunications system for prioritizing browsing to reduce hypertext transfer protocol (HTTP) page download delay, thereby providing consistent service in a wireless communication system.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In some wireless communication networks, one of the numerous causes of HTTP download delay may be the HTTP request-response model. The magnitude of the delay in HTTP download is directly related to the round-trip time (RTT) duration of the system. As such, delays in HTTP object downloads may have significant impacts on systems with large RTT duration even in high data rate transmissions. Thus, improvements in HTTP download delays are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method of reducing round-trip time (RRT) for communications between a proxy and a browser is described. The method includes receiving a webpage from a server in response to forwarding to the server a first request received from the browser. Further, the method includes parsing the webpage for one or more object identifiers. Moreover, the method includes requesting one or more objects from the server based on the one or more object identifiers. Additionally the method includes storing the one or more objects received from the server.

In another aspect, the apparatus are described for reducing RRT for communications between a proxy and a browser is described. The apparatus includes means for receiving a webpage from a server in response to forwarding to the server a first request received from the browser. Further, the apparatus includes means for parsing the webpage for one or more object identifiers. Moreover, the apparatus includes means for requesting one or more objects from the server based on the one or more object identifiers. Additionally the apparatus includes means for storing the one or more objects received from the server.

In another aspect, an apparatus for reducing RRT for communications between a proxy and a browser is described. The apparatus includes a receiving component configured to receive a webpage from a server in response to forwarding to the server a first request received from the browser. Further, the apparatus includes a parsing component configured to parse the webpage for one or more object identifiers. Moreover, the apparatus includes a requesting component configured to request one or more objects from the server based on the one or more object identifiers. Additionally, the apparatus includes a storing component configured to store the one or more objects received from the server.

In yet another aspect, a non-transitory computer-readable media executable by an apparatus for reducing RRT for communications between a proxy and a browser is described. The computer-readable media includes code for receiving a webpage from a server in response to forwarding to the server a first request received from the browser. Further, the computer-readable media includes code for parsing the webpage for one or more object identifiers. Moreover, the computer-readable media includes code for requesting one or more objects from the server based on the one or more object identifiers. Additionally the computer-readable media includes code for storing the one or more objects received from the server.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram illustrating an example wireless system of aspects of the present disclosure.

FIG. 2 is a schematic diagram illustrating exemplary aspect of the proxy component in a wireless communication system.

FIG. 3 is a flow diagram of a method of an aspect for reducing RRT for communications between a proxy and a browser in a wireless communication system.

FIG. 4A is a signaling chart of a message flow of an aspect of HTTP download delay improvement.

FIG. 4B is a signaling chart that includes a continuation of the message flow of FIG. 6A for the aspect of HTTP download delay improvement.

FIGS. 5A and 5B are flowcharts illustrating aspects of HTTP download prioritization.

FIG. 6 is a flowchart illustrating another aspect of HTTP download prioritization at the remote proxy.

FIG. 7 is a diagram illustrating an example of a hardware implementation for an apparatus employing a processing system.

FIG. 8 is a block diagram conceptually illustrating an example of a telecommunications system.

FIG. 9 is a conceptual diagram illustrating an example of an access network.

FIG. 10 is a conceptual diagram illustrating an example of a radio protocol architecture for the user and control planes for a base station and/or a UE configured to perform the functions described herein.

FIG. 11 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to efficiently reducing HTTP page download delays. Specifically, the cellular links in a wireless communication system between user equipments (UEs) and the network generally introduce delays which increase download time for a user of a UE. HTTP protocol follows a “request-response” model, in that, a next GET message (e.g., request a page from a server) is not sent until a RESPONSE for the current GET message is received from the network. In some instances, the delays cause a loss of efficiency especially when the link rates are high. A number of methods may be used to alleviate this issue, including using multiple connections and/or pipelining. Multiple connections may require multiple parallel connections to achieve high link utilization. However, parallel connections may lead to a lower number of transfers per connection, and as such, each connection may suffer low throughput due to Transmission Control Protocol (TCP) slow-start. Pipelining may require all requests to be sent out at once. However, pipelining may require a deep pipe to fill a link with long RTT. Moreover, pipelining may suffer from head-of-line (HoL) blocking problems, especially when the server is overloaded. In HTTP 1.1, all responses need to be sent back in the same order as they were requested. If an object takes longer to retrieve than others, it could delay transmission of the remaining objects until the issue is resolved.

Accordingly, in some aspects, the present methods and apparatuses may provide an efficient solution, as compared to current solutions, by using a pair of proxies located within the network to provide downloading over a single, deep pipeline and provide out-of-order delivery to avoid HoL blocking. In some instances, a proxy may be used to track communications for another device and/or to perform functions and/or operations associated with another device (e.g., web server). As a result, browsing may be prioritized in order to reduce HTTP page download delay, thereby providing consistent service in a wireless communication system.

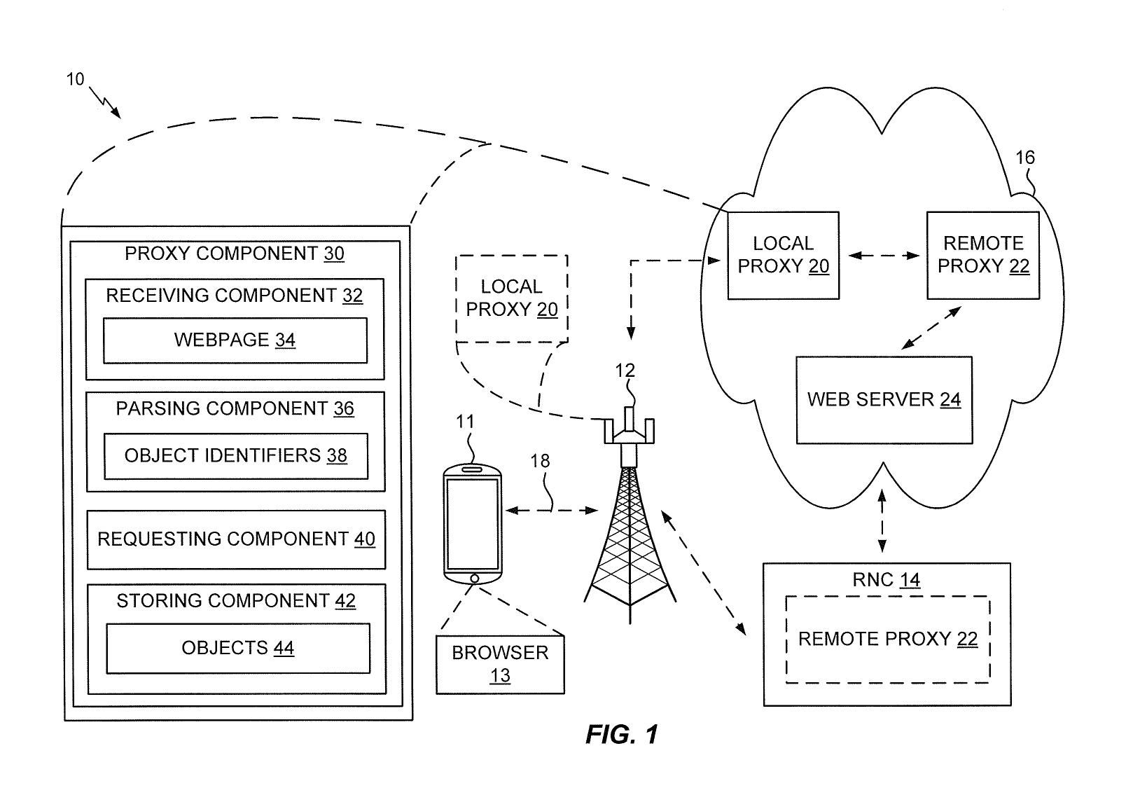

Referring to FIG. 1, in one aspect, a wireless communication system 10 is configured to prioritize browsing to reduce HTTP page download delay, thereby providing consistent service in a wireless communication system. Wireless communication system 10 includes at least one user equipment (UE) 11 that may communicate wirelessly with one or more networks (e.g., network 16) via one or more network entities, including, but not limited to, network entity 12. UE 11 may communicate with network 16 via network entity 12. For example, in an aspect, network entity 12 may be a base station configured to transmit and receive one or more signals via one or more communication channels 18 to/from UE 11. In an aspect, the requests may be made in response to inputs provided to a browser 13 operating on UE 11. For instance, one or more signals may include requests such as HTTP requests (e.g., GET message). In certain instances, the request may include a request line which requests a resource from a server, a request header, an empty line, and an optional message body. As a result, the server may transmit a response to the request, which may include a status-line which indicates whether the client's request succeeded, a response header, an empty line, and an optional message body.

In certain aspects, network entity 12 may communicate with network 16 directly or via radio network controller (RNC) 14. Accordingly, network 16 may include remote proxy 22, which may be configured to receive HTTP requests from local proxy 20. In some instances, a proxy may be used to track communications for another device and/or to perform functions and/or operations associated with another device (e.g., web server 24). In other aspects, remote proxy 22 may be located at RNC 14. As such, the local proxy 20 may be located at network entity 12. Network 16 may further include remote proxy 22 and web server 24. In some aspects, remote proxy 22 may be configured to provide communication between local proxy 20 and web server 24 in order to facilitate requests received from UE 11. Local proxy 20 and remote proxy 22 may prioritize browsing to reduce HTTP page download delay by determining whether a request originated from a browser (e.g., browser 13) or a local proxy (e.g., local proxy 20).

In an aspect, local proxy 20 may include proxy component 30, which may be configured to receive a webpage 34 via receiving component 32 from web server 24 in response to receiving a request from the browser 13 at UE 11. For example, a user operating UE 11 may configure browser 13 to access a webpage, such as webpage 34. UE 11 may communicate an HTTP request, such as a GET message, via communication channel 18 to network entity 12 and subsequently to local proxy 20. Local proxy 20 may forward the GET message for the webpage 34 to remote proxy 22, which may in turn forward the GET message to web server 24. Upon receiving the GET message, web server 24 may determine the webpage 34 that corresponds to the GET message and transmit webpage 34 (e.g., as part of an HTTP OK: main page message) back to remote proxy 22. Remote proxy 22 may forward the webpage 34 to local proxy 20. The local proxy 20 may then transmit the webpage 34 to UE 11 and/or browser 13.

Additionally, in some aspects, local proxy 20 may include parsing component 36, which may be configured to parse the webpage 34 for one or more object identifiers 38. For example, object identifiers 38 identify objects 44 comprised in the webpage 34 and stored at web server 24. In some instances, objects 44 may include cascading style sheets (CSS) related objects, image files, HyperText Markup Language (HTML) files, Javascript, and/or inline Javascript that may be pre-fetched by local proxy 20. Parsing component 36 may parse the webpage 34 for object identifiers 38 corresponding to any of these types of objects 44.

Further, in an aspect, local proxy 20 may include requesting component 40, which may be configured to request one or more objects 44 from the web server 24 based on the one or more object identifiers 38. For example, proxy component 30 and/or requesting component 40 may be configured to pre-fetch objects 44 corresponding to webpage 34 before the user operating browser 13 on UE 11 transmits a request, such as an HTTP request (e.g., GET message) for one of the objects 44. As such, requesting component 40 may transmit one or more requests (e.g., GET messages) to remote proxy 22, which may in turn forward the requests to web server 24. Web server 24 may process the received requests and determine the objects 44 that corresponds with each one of the object identifiers 38 for the webpage 34. Web server 24 may then transmit the objects 44 as part of one or more response (RESP) messages to local proxy 20 via remote proxy 22.

In another aspect, proxy component 30 may include storing component 42, which may be configured to store the one or more objects 44 received from web server 24. For example, the objects 44 may correspond to the webpage 34 that the user of UE 11 is currently accessing on browser 13, and in some instances, has yet to request. These pre-fetched objects 44 are stored at local proxy 20 so that once a request (e.g., GET message) is received for one or more of these objects 44, the local proxy 20 may transmit a response with the one or more objects 44 without having to forward the request to the web server 24 and wait for a response. Pre-fetching and storing objects 44 reduces the RTT delay that exists with the “request-response” model for HTTP requests.

UE 11 may comprise a mobile apparatus and may be referred to as such throughout the present disclosure. Such a mobile apparatus or UE 11 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Additionally, the one or more wireless nodes, including, but not limited to, network entity 12 of wireless communication system 10, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 10 may include one or more small cell base stations, such as, but not limited to a femtocell, picocell, microcell, or any other base station having a relatively small transmit power or relatively small coverage area as compared to a macro base station.

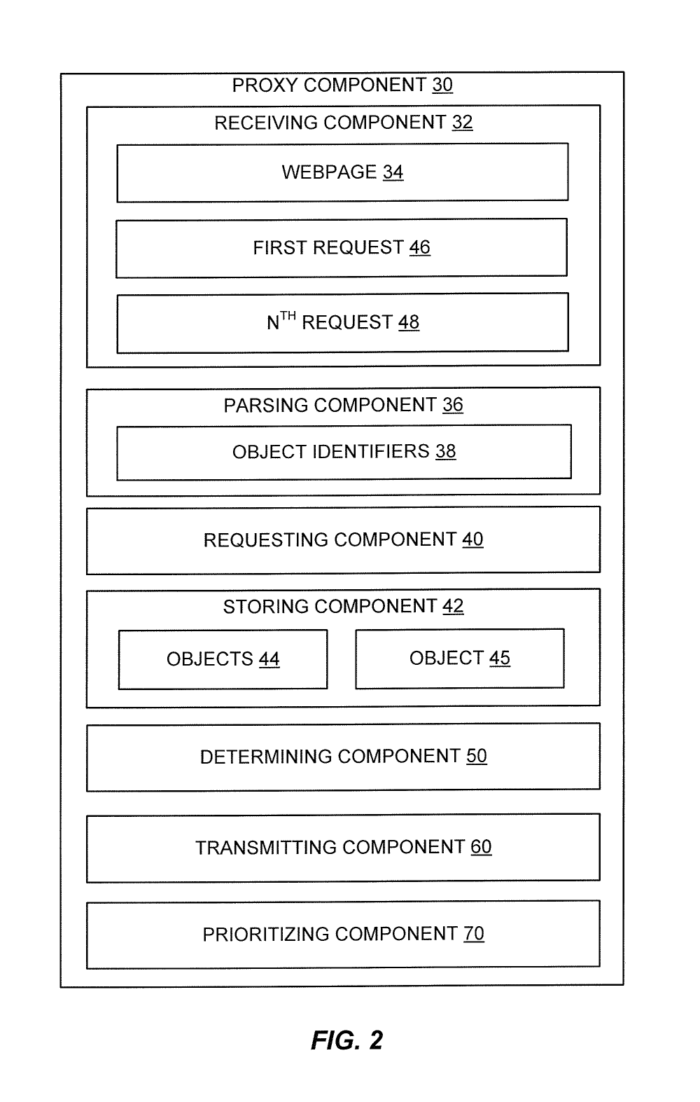

FIG. 2 is a schematic diagram of an aspect of the proxy component 30, which resides in local proxy 20 of FIG. 1. Generally, local proxy 20 may reside in network 16 (FIG. 1) and/or optionally network entity 12 and may be configured to receive one or more requests, such HTTP requests (e.g., GET messages) from browser 13 operating on UE 11 via network entity 12. In some instances, a proxy may be used to track communications for another device and/or to perform functions and/or operations associated with another device (e.g., web server 24). Local proxy 20 may be configured to provide a communication link between the browser 13 (FIG. 1) and web server 24, as well as, provide the capability of pre-fetching one or more objects 44 corresponding to a webpage 34 being currently accessed by browser 13. These pre-fetched objects 44 are stored at local proxy 20 so that once a request (e.g., GET message) is received for one or more of these objects 44, the local proxy 20 may transmit a response with the one or more objects 44 without having to forward the request to the web server 24 and wait for a response. Pre-fetching and storing objects 44 reduces the RTT delay that exists with the “request-response” model for HTTP requests. Moreover, local proxy 20 may be configured to prioritize requests based on the origination of each of the requests.

In some aspects, proxy component 30 may include receiving component 32 (FIG. 1), which may be configured to receive a webpage 34 from web server 24 (FIG. 1) in response to the local proxy 20 receiving a request, such as an HTTP request (e.g., GET message) from the browser 13 operating at UE 11. For example, receiving component 32 may communicate with remote proxy 22 in order to forward the request received from the browser to web server 24. Web server 24 may process the request and respond by transmitting a webpage 34 based on the request to remote proxy 22. Remote proxy 22 forwards the webpage 34 to local proxy 20 and/or receiving component 32. Local proxy 20 may in turn forward the webpage 34 to UE 11 and/or browser. For example, a user operating UE 11 (FIG. 1) may configure browser 13 to access a webpage, such as webpage 34. UE 11 may communicate an HTTP request, such as a GET message, via communication channel 18 to network entity 12 and subsequently to local proxy 20. Local proxy 20 may forward the GET message for the webpage 34 to remote proxy 22 which may in turn forward the GET message to web server 24. Upon receiving the GET message, web server 24 may determine the webpage 34 that corresponds to the GET message and transmit webpage 34 (e.g., as part of an HTTP OK: main page message) back to remote proxy 22. Remote proxy 22 may forward the webpage 34 to local proxy 20. The local proxy 20 may then transmit the webpage 34 to UE 11 and/or browser 13.

In certain aspects, receiving component 32 may receive one or more requests from browser 13. For example, receiving component 32 may receive a first request 46 from browser 13. In some instances, first request 46 may correspond to an HTTP request (e.g., GET message) for a webpage 34. Further, receiving component 32 may receive one or more subsequent requests (e.g., N^{th} request 48) corresponding to one or more objects 44 associated with webpage 34. In certain instances, the one or more subsequent requests (e.g., Nth request 48) may be originated by the local proxy 20 as part of a pre-fetch procedure for the webpage 34. The receiving component 32 is further configured to identify the first request 46 from the browser 13 as HTTP traffic.

In other aspects, proxy component 30 may include parsing component 36 (FIG. 1), which may be configured to parse the webpage 34 for one or more object identifiers 38. For example, parsing component 36 may parse the webpage 34 for one or more object identifiers 38 corresponding to one or more objects 44 that are stored at web server 24. In some instances, objects 44 may include cascading style sheets (CSS) related objects, image files, HyperText Markup Language (HTML) files, Javascript, and/or inline Javascript that may be pre-fetched by local proxy 20. Parsing component 36 may parse the webpage 34 for object identifiers 38 corresponding to any of these types of objects 44. Additionally, parsing component 36 may parse the HTML code of the webpage 34 to determine objects identifiers 38 located within the HTML code. Specifically, objects 44 may be identified by object identifiers 38 located within the HTML code. In some instances, object identifiers 38 may be in the form of HTTP addresses (e.g., Uniform Resource Locators (URLs)) corresponding to the addresses of the objects 44 in web server 24.

Further, in an aspect, proxy component 30 may include requesting component 40 (FIG. 1), which may be configured to request one or more objects 44 from web server 24. For example, requesting component 40 may request one or more objects 44 from web server 24 based on the one or more object identifiers 38 parsed from the webpage 34 by parsing component 36. In some instances, proxy component 30 and/or requesting component 40 may be configured to pre-fetch objects 44 corresponding to webpage 34 before the user operating browser 13 on UE 11 transmits a request, such as an HTTP request (e.g., GET message) for one of the objects 44. As such, requesting component 40 may transmit one or more requests (e.g., GET messages) to remote proxy 22, which may in turn forward the requests to web server 24. Web server 24 may process the received requests and determine the objects 44 that correspond with each one of the object identifiers 38 for the webpage 34. In certain instances, the GET messages may each include an object identifier 38 in the form of an HTTP address (e.g., URL) of the specific object 44 being requested. Web server 24 may match the object identifier 38 with the object 44 located in web server 24. Web server 24 may then transmit the objects 44 as part of one or more response (RESP) messages to local proxy 20 via remote proxy 22.

In another aspect, proxy component 30 may include storing component 42 (FIG. 1), which may be configured to store the one or more objects 44 received from web server 24. For example, the objects 44 correspond to the webpage 34 that the user of UE 11 is currently accessing on browser 13, and in some instances, has yet to request. These pre-fetched objects 44 are stored at local proxy 20 so that once a request (e.g., GET message) is received for one or more of these objects 44, the local proxy 20 may transmit a response with the one or more objects 44 without having to forward the request to the web server 24 and wait for a response. Pre-fetching and storing objects 44 reduces the RTT delay that exists with the “request-response” model for HTTP requests. The storing component 42 is further configured to record a transaction identification (ID) located in a header of the first request 46. The requesting component 40 may then request the webpage 34 from the server 24 in response to recording the transaction ID.

In another aspect, proxy component 30 may include determining component 50, which may be configured to determine whether an object 45 was previously requested. For example, determining component 50 may analyze N^{th} request 48, and determine whether the object 45 being requested has been previously requested. In some instances, one or more objects 44 may have been previously requested (e.g., pre-fetched). In these instances, determining component 50 may indicate that the object 45 corresponding to the N^{th} request 48 has already been requested if it matches one of the one or more objects 44, so that requesting component 40 does not unnecessarily transmit a request (e.g., GET message) to web server 24 for the object 45. However, if determining component 50 determines that the object 45 being requested has not been previously requested then an indication may be sent to requesting component 40 to request the object 45 from web server 24.

Additionally, in an aspect, proxy component 30 may include transmitting component 60, which may be configured to transmit the one or more objects 44 and/or 45 received from the web server 24 to the browser 13. For example, receiving component 32 may receive the one or more objects 44 and/or 45 from web server 24 via remote proxy 22. Once received, proxy component 30 may configure transmitting component 60 to transmit the one or more objects 44 and/or 45 to browser 13. Moreover, if the one or more objects 44 and/or 45 have been pre-fetched, then proxy component 30 may configure transmitting component 60 to transmit the pre-fetched objects 44 and/or 45 to browser 13 without the need for requesting component 40 to transmit a request to the web server 24.

In some aspects, proxy component 30 may include prioritizing component 70, which may be configured to prioritize a request for the one or more objects. For example, once a request (e.g., Nth request 48) is received by proxy component 30, prioritizing component 70 may determine whether the request was received from the browser 13 or if the local proxy 20 originated the request as part of a pre-fetch procedure for one or more objects 44 corresponding to the webpage 34. In some instances, if a request originated from browser 13 then prioritizing component 70 may include an indication with the request, wherein the indication is set to a high priority level. However, if a request originated from local proxy 20 then prioritizing component 70 may include an indication with the request, wherein the indication is set to a low priority level. In certain instances, requests with indications set to high priority levels may be transmitted to the remote proxy 22 before requests with indications set to low priority levels. This procedure allows for prioritizing requests made by the user operating the browser 13 on UE 11 over requests made by local proxy 20 during a pre-fetch procedure. As such, if the local proxy 20 is still performing the pre-fetch procedure for one or more objects 44 and a new request for an object 44 that has yet to be requested is received from the browser 13, then prioritizing component 70 may prioritizing the new request with an indication set to high priority level. Moreover, prioritizing requests solves the issue of HoL that may occur when processing browsing requests.

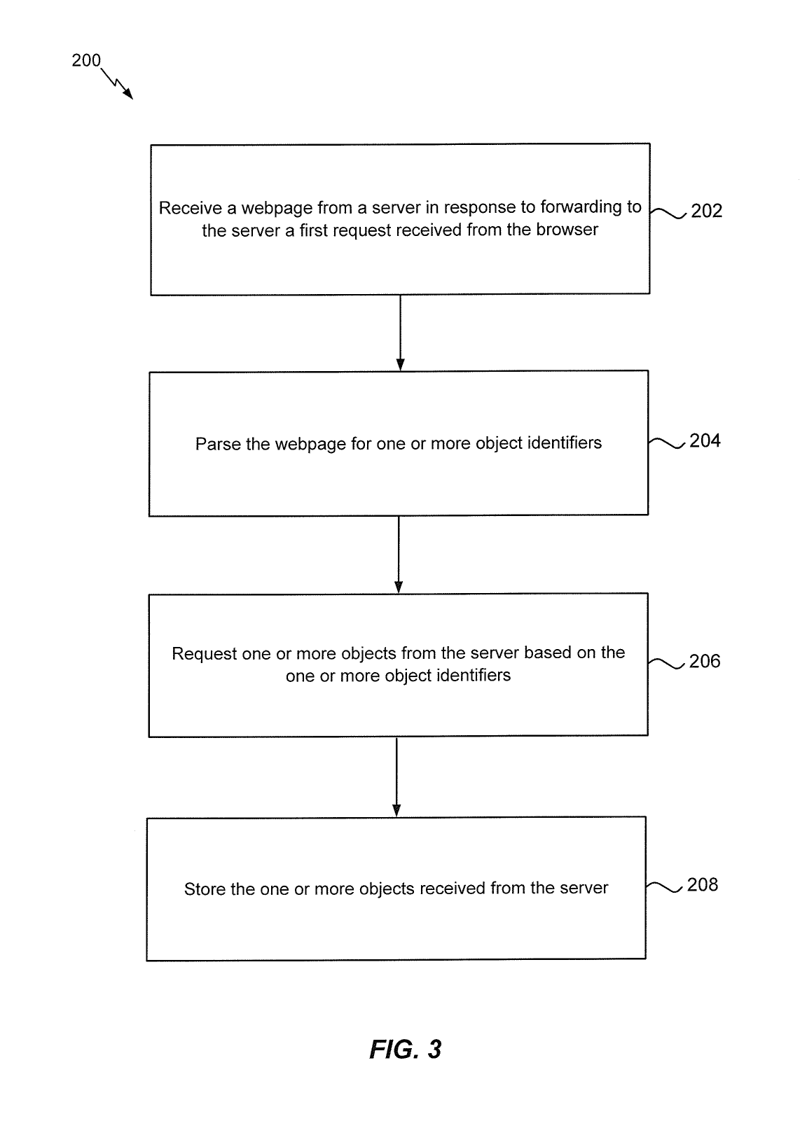

Referring to FIG. 3, in operation, a local proxy such as local proxy 20 (FIG. 1) may perform one aspect of a method 200 for prioritizing browsing to reduce HTTP page download delay. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein.

In an aspect, at block 202, method 200 may include receiving a webpage from a server in response to forwarding to the server a first request received from the browser. For example, as described herein, proxy component 30 may configure receiving component 32 to receive a webpage 34 from a web server 24 (FIG. 1) in response to forwarding to the server 24 a first request 46 received from the browser 13 operating on UE 11. In some instances, the first request 46 may be an HTTP request (e.g., GET message) in which the proxy component 30 forwards to web server 24 in order to receive the webpage 34 corresponding to the first request 46.

At block 204, method 200 may include parsing the webpage for one or more object identifiers. For example, as described herein, proxy component 30 may configure parsing component 36 to parse the webpage 34 for one or more object identifiers 38. In some instances, proxy component 30 may pre-fetch one or more objects 44 corresponding to the webpage 34 being accessed by browser 13 (FIG. 1). As such, parsing component 36 may be configured to determine object identifiers 38 that correspond to the one or more objects 44 to be pre-fetched.

Further, at block 206, method 200 may include requesting one or more objects from the server based on the one or more object identifiers. For example, as described herein, proxy component 30 may configure requesting component 40 to request one or more objects 44 from the web server 24 (FIG. 1) based on the one or more object identifiers 38.

Additionally, at block 208, method 200 may include storing the one or more objects received from the server. For example, as described herein, proxy component 30 may configure storing component 42 to store the one or more objects 44 received from the web server 24 (FIG. 1). As a result, for example, proxy component 30 may further be configured to receive a second request from the browser for an object; and determine whether the object was previously requested from the server prior to receiving the second request from the browser. As such, proxy component 30 may be configured to forward the second request to the server based on the determination that the object was not previously requested; receiving a response including the object from the server in response to the second request; and transmitting the object received from the server to the browser. Alternatively, proxy component 30 may be configured to determine that the object was received from the server when a determination is made that the object was previously requested; and transmit the object to the browser in response to determining that the object was received from the server.

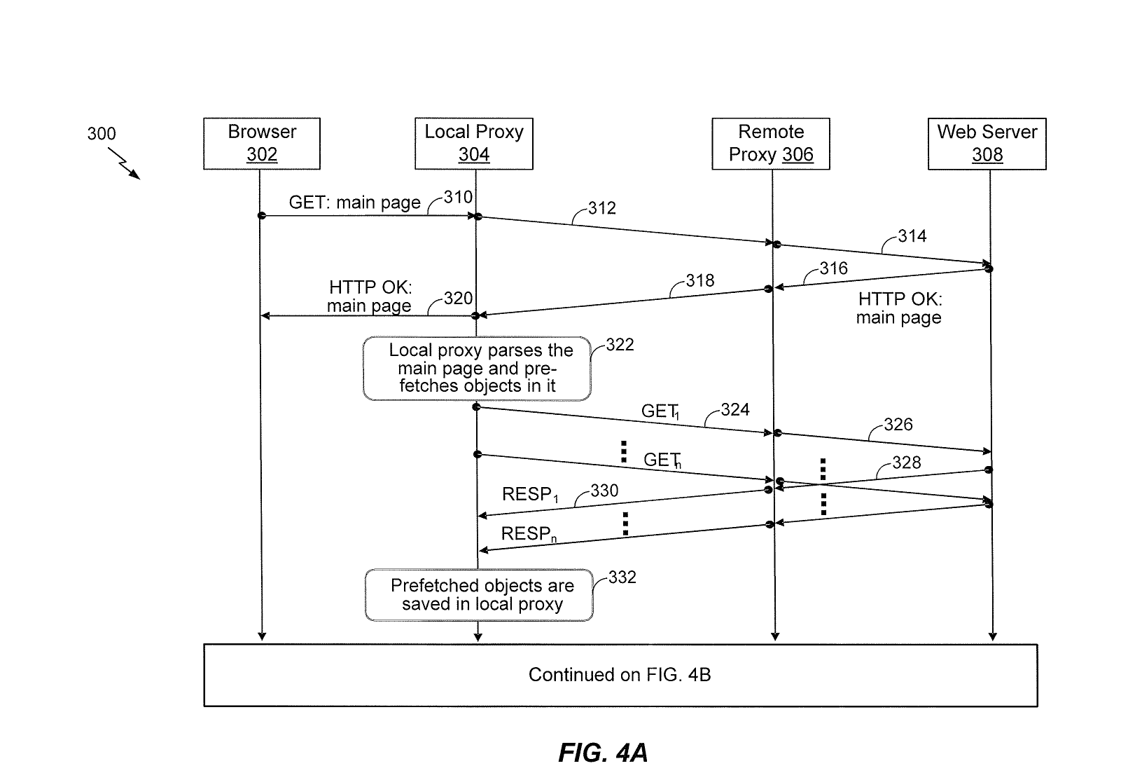

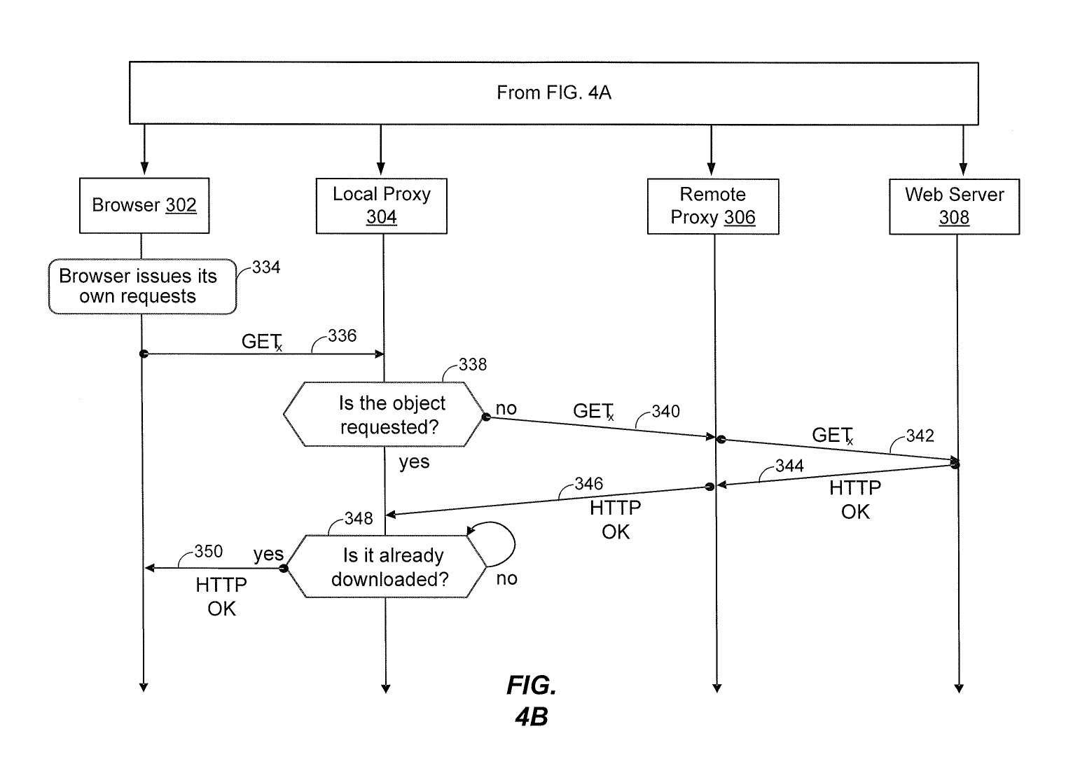

Referring to FIGS. 4A and 4B, in operation, a signaling chart 300 illustrating the signaling for reducing HTTP page download delay that occurs between browser 302, local proxy 304, remote proxy 306, and web server 308. In some instances, a proxy may be used to track communications for another device and/or to perform functions and/or operations associated with another device (e.g., web server 308). In certain instances, browser 302 may be a browser operating on a UE, such as browser 13 and UE 11 (FIG. 1). Further, local proxy 304, remote proxy 306, and web server 308 may be located within a network of a wireless communication system, such as local proxy 20, remote proxy 22, and web server 24 located in network 16 (FIG. 1). Alternatively, local proxy 304 and remote proxy 306 may be located at a network entity and an RNC, respectively, such as local proxy 20 located at network entity 12 and remote proxy 22 located at RNC 14 (FIG. 1). While, for purposes of simplicity of explanation, the steps herein are shown and described as a series of acts, it is to be understood and appreciated that the steps are not limited by the order of acts, as some acts may, in accordance with one or more aspects, occur in different orders and/or concurrently with other acts from that shown and described herein. For example, it is to be appreciated that the steps could alternatively be represented as a series of interrelated states or events, such as in a state diagram. Moreover, not all illustrated acts may be required to implement a step in accordance with one or more features described herein.

Referring to FIG. 4A, at 310, browser 302 may transmit a request to local proxy 304.

For example, browser 302 may transmit an HTTP request, such as a GET message corresponding to a request for a main webpage. At 312, upon receipt of the request, local proxy 304 may forward the request to remote proxy 306, which in turn forwards the request to web server 308 at 314.

Further, in an aspect, at 316, web server 308 may transmit a response to the request received from remote proxy 306. For example, web server 308 may process the received request and determine a webpage (e.g., webpage 34 in FIG. 1) that corresponds to the request. As a result, web server 308 may transmit an HTTP OK message including the main webpage to remote proxy 306.

In some aspects, at 318, remote proxy 306 may forward the response from the web server 308 to local proxy 304. Additionally, at 320, local proxy 304 may transmit the response (e.g., HTTP OK: main webpage) to browser 302. As a result, browser 302 may provide access to the webpage to the user.

In an aspect, at 322, local proxy 304 may (either before or after transmitting the response to the browser 302 in 320) parse the main webpage and pre-fetch objects associated with the main webpage. For example, local proxy 304 may parse the webpage for one or more object identifiers. In some instances, local proxy 304 may pre-fetch one or more objects corresponding to the webpage being accessed by browser 302. As such, local proxy 304 may be configured to determine object identifiers that correspond to the one or more objects to be pre-fetched.

Moreover, at 324, local proxy 304 may request one or more objects based on the parsing of the main webpage in 322. For example, local proxy 304 may transmit a request for an object for each corresponding object identifier parsed from the main webpage. As such, the one or more requests may correspond to HTTP requests such as GET messages (e.g., GET₁ to GETₙ, where n is an integer greater than one and corresponds to the number of objects to be pre-fetched for the main webpage). In some instances, local proxy 304 may transmit the one or more requests to remote proxy 306, which in turn may forward the one or more requests to web server 308 in 326.

In some aspects, at 328, web server 308 may transmit one or more responses corresponding to the one or more requests received from remote proxy 306. For example, web server 308 may process each of the received requests and determine an object corresponding to each object identifier. As such, web server 308 may transmit one or more responses (e.g., RESP₁ to RESPₙ, where n is an integer greater than one and corresponds to the number of objects to be pre-fetched for the main webpage) including each of the object to remote proxy 306. In turn, at 330, remote proxy 306 may forward the one or more responses including the one or more objects to local proxy 304. Additionally, at 332, local proxy 304 may store the one or more objects pre-fetched from web server 308.

Referring to FIG. 4B, at 334, browser 302 may transmit a request for one of the objects corresponding to the main webpage previously requested. For example, browser 302 may transmit a GET message (e.g., GETx, where x is an integer greater than zero corresponding to each of the objects the browser is requesting) to local proxy 304. At 338, local proxy 304 may determine whether the object that browser 302 requested has already been requested during the pre-fetching procedure (e.g., at 322 of FIG. 4A). If local proxy 304 determines that the object has not been requested yet then local proxy 304 may transmit a request for the object to the remote proxy 306 in 340. For example, local proxy 304 may forward the request received from browser 302 (e.g., GETₓ) to remote proxy 306. In turn, at 342, remote proxy 306 may forward the request (e.g., GETₓ) to web server 308 for processing.

In an aspect, at 344, web server 308 may transmit a response to remote proxy 306 including the object corresponding to request (e.g., GETₓ). For example, web server 308 may process each of the received requests and determine an object corresponding to each request. As such, web server 308 may transmit one or more responses (e.g., HTTP OK) including each of the object to remote proxy 306. In turn, at 346, remote proxy 306 may forward the one or more responses including the one or more objects to local proxy 304.

At 338, if local proxy 304 determines that the object has been previously requested then local proxy 304 may not transmit a request to remote proxy 306 in 340. Instead, at 348, local proxy 304 may determine whether the previously requested object has been received (e.g., downloaded and stored) yet from web server 308. If the object has not been received yet then local proxy 304 may wait until the object is received. However, if the object has already been received from web server 308, then local proxy 304 may transmit the object to browser 302 at 350. For example, local proxy 304 may transmit an HTTP OK message including the object to browser 302.

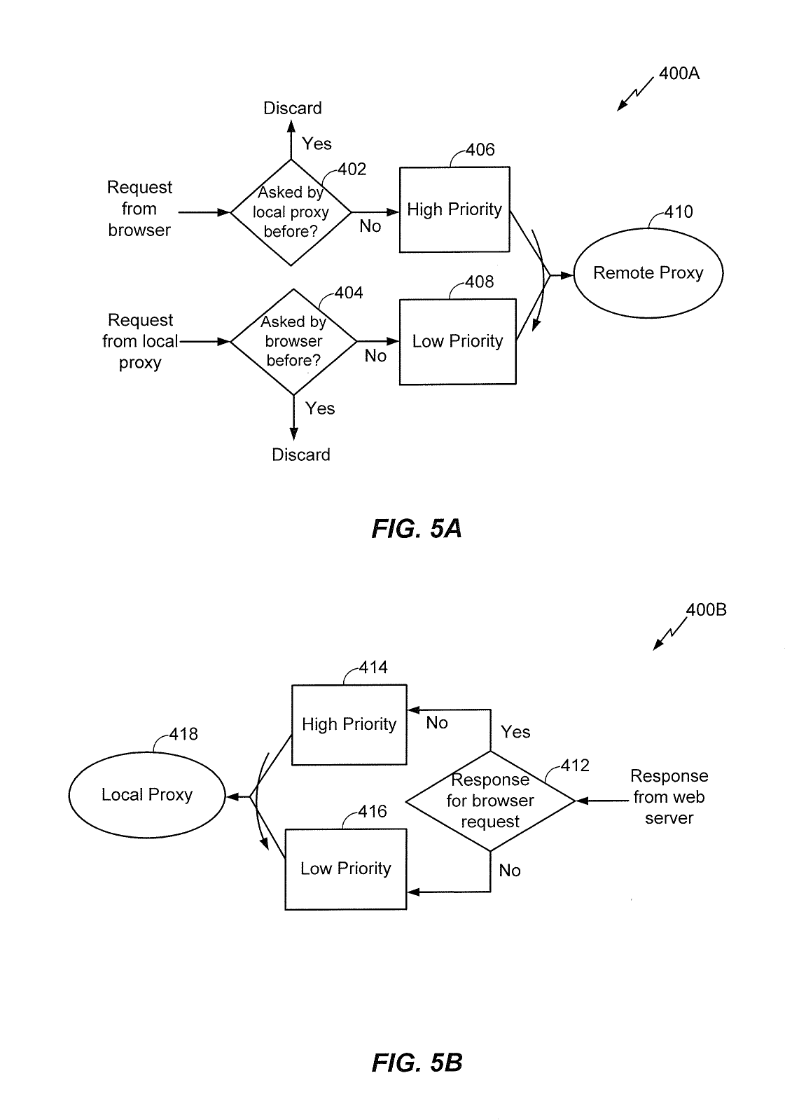

Referring to FIGS. 5A and 5B, in operation, flowcharts 400A and 400B illustrate prioritizing browsing signaling to reduce HTTP page download delay that occurs between browser, local proxy, remote proxy, and web server. In certain instances, browser may be a browser operating on a UE, such as browser 13 and UE 11 (FIG. 1). Further, local proxy, remote proxy, and web server may be located within a network of a wireless communication system, such as local proxy 20, remote proxy 22, and web server 24 located in network 16 (FIG. 1), for example. Alternatively, local proxy and remote proxy may be located at a network entity and an RNC, respectively, such as local proxy 20 located at network entity 12 and remote proxy 22 located at RNC 14 (FIG. 1), for example. While, for purposes of simplicity of explanation, the steps herein are shown and described as a series of acts, it is to be understood and appreciated that the steps are not limited by the order of acts, as some acts may, in accordance with one or more aspects, occur in different orders and/or concurrently with other acts from that shown and described herein. For example, it is to be appreciated that the steps could alternatively be represented as a series of interrelated states or events, such as in a state diagram. Moreover, not all illustrated acts may be required to implement a step in accordance with one or more features described herein.

Referring to FIG. 5A, flowchart 400A may be performed by a local proxy, such as local proxy 20 (FIG. 1), which is configured with proxy component 30. In some instances, a proxy may be used to track communications for another device and/or to perform functions and/or operations associated with another device (e.g., web server 24). In an aspect, at block 402, the local proxy may receive a request from the browser, such as browser 13 (FIG. 1). For example, the request may correspond to an HTTP request (e.g., GET message) for a webpage or an object corresponding to the webpage. Then, local proxy may determine whether the request has been previously asked by the local proxy. If local proxy determines that the request has been previously requested then the request from the browser is discarded. However, if local proxy determines that the request has not been previously requested from the browser then the request is given a high priority at block 406. At block 410, the request with the indication of the high priority, may be transmitted from the local proxy to the remote proxy.

Alternatively, at block 404, the local proxy may receive a request from the local proxy itself For example, the request may be as a result of performing a pre-fetch procedure for one or more objects after the local proxy has parsed a webpage for object identifiers. As such, local proxy may determine whether the request has been previously requested by the browser and if so, then the request is discarded. However, if the local proxy determines that the request has not been previously requested by the browser then the request is given a low priority at block 408. At block 410, the request with the indication of the low priority, may be transmitted from the local proxy to the remote proxy.

Referring to FIG. 5B, flowchart 400B may be performed by a remote proxy, such as remote proxy 22 (FIG. 1). In an aspect, at block 412, the remote proxy may receive a response from the web server, such as web server 24 (FIG. 1). Remote proxy may determine whether the response corresponds to a request received from a browser, such as browser 13 (FIG. 1). If the remote proxy determines that the response from the web server corresponds to the request from the browser then the response is given a high priority indication at block 414. However, if the remote proxy determines that the response from the web server corresponds to the request from the local proxy then the response is given a low priority indication in block 416. Following either at blocks 414 and 416, the response with the indication of priority is transmitted to local proxy at block 418.

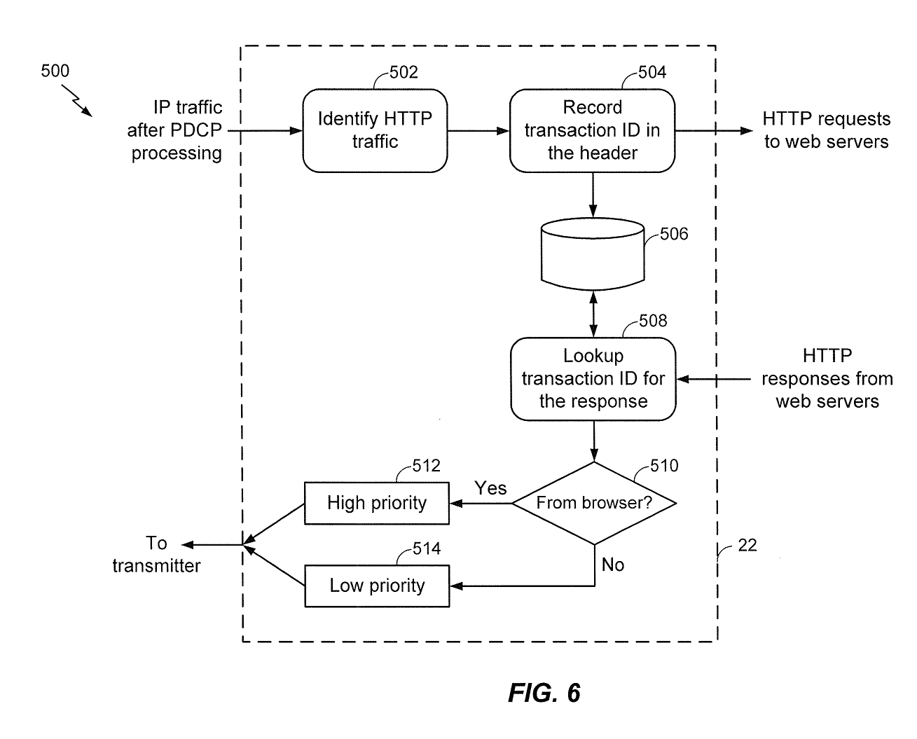

Referring to FIG. 6, a conceptual diagram 500 illustrates prioritizing browsing signaling to reduce HTTP page download delay that occurs at a remote proxy located at an RNC, such as remote proxy 22 located at RNC 14 (FIG. 1). In some instances, a proxy may be used to track communications for another device and/or to perform functions and/or operations associated with another device (e.g., web server 24). While, for purposes of simplicity of explanation, the steps herein are shown and described as a series of acts, it is to be understood and appreciated that the steps are not limited by the order of acts, as some acts may, in accordance with one or more aspects, occur in different orders and/or concurrently with other acts from that shown and described herein. For example, it is to be appreciated that the steps could alternatively be represented as a series of interrelated states or events, such as in a state diagram. Moreover, not all illustrated acts may be required to implement a step in accordance with one or more features described herein.

In an aspect, at block 502, remote proxy may receive internet protocol (IP) traffic after Packet Data Convergence Protocol (PDCP) processing has occurred, and identify HTTP traffic included in the IP traffic. PDCP is one of the layers of the Radio Traffic Stack in UMTS and performs IP header compression and decompression, transfer of user data and maintenance of sequence numbers for Radio Bearers which are configured for lossless serving radio network subsystem (SRNS) relocation. At block 504, the remote proxy may record the transaction identification (ID) in the header for each HTTP traffic and transmit the HTTP requests to web servers, such as web server 24 (FIG. 1). In some instances, the HTTP requests may correspond to requests for a webpage (e.g., webpage 34 in FIG. 1) or an object associated with the webpage (e.g., objects 44). In certain instances, the remote proxy may record the transaction ID in memory 506 located at the remote proxy.

At block 508, the remote proxy may receive HTTP responses from one or more of the web servers, and as a result, look up the transaction ID for each the responses. For example, the remote proxy may receive an HTTP response from a web server (e.g., web server 24 in FIG. 1) and be configured to look up the transaction ID for the response in memory 506. In some instances, the transaction ID for the response should match the transaction ID for the HTTP request stored at block 504. After the transaction ID is found, the remote proxy determines whether the HTTP request corresponding to the HTTP response was received from a browser (e.g., browser 13 in FIG. 1) at block 510. If the remote proxy determines that the response from the web server corresponds to a request from the browser then the response is given a high priority indication at block 512. However, if the remote proxy determines that the response from the web server corresponds to the request from a local proxy then the response is given a low priority indication at block 514. Following either at blocks 512 and 514, the response with the indication of priority is transmitted to local proxy.

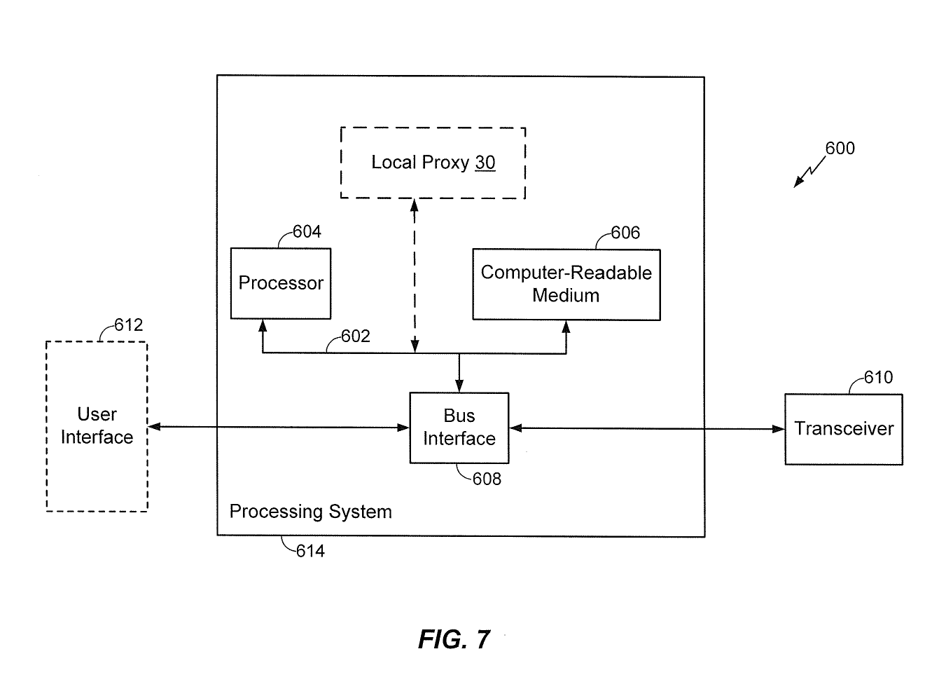

FIG. 7 is a conceptual diagram illustrating an example of a hardware implementation for an apparatus 600 employing a processing system 614, where apparatus 600 may be local proxy 20 (FIG. 1) or may be included with local proxy 20, and where apparatus 600 is configured with proxy component 30 for performing the actions described herein. In this example, the processing system 614 may be implemented with a bus architecture, represented generally by the bus 602. The bus 602 may include any number of interconnecting buses and bridges depending on the specific application of the processing system 614 and the overall design constraints. The bus 602 links together various circuits including one or more processors, represented generally by the processor 604, and computer-readable media, represented generally by the computer-readable medium 606. The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided.

The processor 604 is responsible for managing the bus 602 and general processing, including the execution of software stored on the computer-readable medium 606. The software, when executed by the processor 604, causes the processing system 614 to perform the various functions described infra for any particular apparatus. The computer-readable medium 606 may also be used for storing data that is manipulated by the processor 604 when executing software.

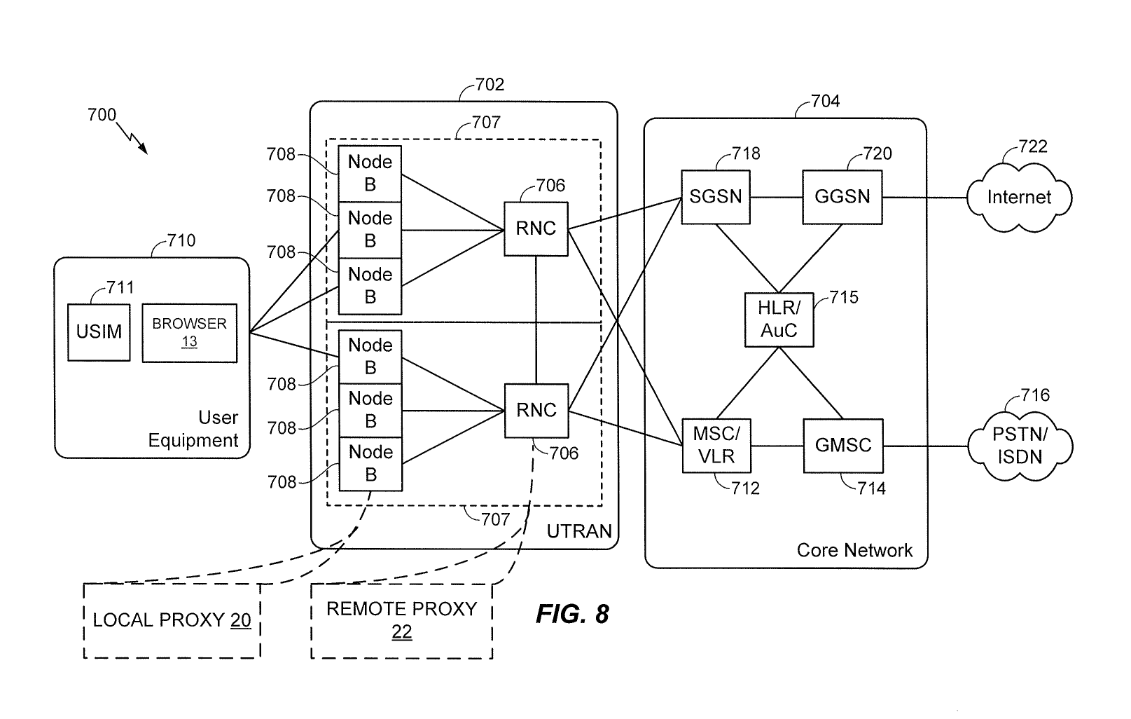

The various concepts presented throughout this disclosure may be implemented across a broad variety of telecommunication systems, network architectures, and communication standards. By way of example and without limitation, the aspects of the present disclosure illustrated in FIG. 8 are presented with reference to a UMTS system 700 employing a W-CDMA air interface. In this case, NodeBs 708 may be the same as or similar to network entity 12 of FIG. 1, and may include local proxy 20 as described herein. Similarly, RNCs 706 may be the same as or similar to RNC 14 of FIG. 1, and may include remote proxy 22 as described herein. A UMTS network includes three interacting domains: a Core Network (CN) 704, a UMTS Terrestrial Radio Access Network (UTRAN) 702, and User Equipment (UE) 710, which may be the same as or similar to UE 11 of FIG. 1, and may include browser 13 as described herein. In this example, the UTRAN 702 provides various wireless services including telephony, video, data, messaging, broadcasts, and/or other services. The UTRAN 702 may include a plurality of Radio Network Subsystems (RNSs) such as an RNS 707, each controlled by a respective Radio Network Controller (RNC) such as an RNC 706. Here, the UTRAN 702 may include any number of RNCs 706 and RNSs 707 in addition to the RNCs 706 and RNSs 707 illustrated herein. The RNC 706 is an apparatus responsible for, among other things, assigning, reconfiguring and releasing radio resources within the RNS 707. The RNC 706 may be interconnected to other RNCs (not shown) in the UTRAN 702 through various types of interfaces such as a direct physical connection, a virtual network, or the like, using any suitable transport network.

Communication between a UE 710 and a Node B 708 may be considered as including a physical (PHY) layer and a medium access control (MAC) layer. Further, communication between a UE 710 and an RNC 706 by way of a respective Node B 708 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 707 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 708 are shown in each SRNS 707; however, the SRNSs 707 may include any number of wireless Node Bs. The Node Bs 708 provide wireless access points to a core network (CN) 704 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 710 may further include a universal subscriber identity module (USIM) 711, which contains a user's subscription information to a network. For illustrative purposes, one UE 710 is shown in communication with a number of the Node Bs 708. The downlink (DL), also called the forward link, refers to the communication link from a Node B 708 to a UE 710, and the uplink (UL), also called the reverse link, refers to the communication link from a UE 710 to a Node B 708.

The core network 704 interfaces with one or more access networks, such as the UTRAN 702. As shown, the core network 704 is a GSM core network. However, as those skilled in the art will recognize, the various concepts presented throughout this disclosure may be implemented in a RAN, or other suitable access network, to provide UEs with access to types of core networks other than GSM networks.

The core network 704 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 704 supports circuit-switched services with a MSC 712 and a GMSC 714. In some applications, the GMSC 714 may be referred to as a media gateway (MGW). One or more RNCs, such as the RNC 706, may be connected to the MSC 712. The MSC 712 is an apparatus that controls call setup, call routing, and UE mobility functions. The MSC 712 also includes a visitor location register (VLR) that contains subscriber-related information for the duration that a UE is in the coverage area of the MSC 712. The GMSC 714 provides a gateway through the MSC 712 for the UE to access a circuit-switched network 716. The core network 704 includes a home location register (HLR) 715 containing subscriber data, such as the data reflecting the details of the services to which a particular user has subscribed. The HLR is also associated with an authentication center (AuC) that contains subscriber-specific authentication data. When a call is received for a particular UE, the GMSC 714 queries the HLR 715 to determine the UE's location and forwards the call to the particular MSC serving that location.

The core network 704 also supports packet-data services with a serving GPRS support node (SGSN) 718 and a gateway GPRS support node (GGSN) 720. GPRS, which stands for General Packet Radio Service, is designed to provide packet-data services at speeds higher than those available with standard circuit-switched data services. The GGSN 720 provides a connection for the UTRAN 702 to a packet-based network 722. The packet-based network 722 may be the Internet, a private data network, or some other suitable packet-based network. The primary function of the GGSN 720 is to provide the UEs 710 with packet-based network connectivity. Data packets may be transferred between the GGSN 720 and the UEs 710 through the SGSN 718, which performs primarily the same functions in the packet-based domain as the MSC 712 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 708 and a UE 710. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 710 provides feedback to the node B 708 over the HS-DPCCH to indicate whether it correctly decoded a packet on the downlink.

HS-DPCCH further includes feedback signaling from the UE 710 to assist the node B 708 in taking the right decision in terms of modulation and coding scheme and precoding weight selection, this feedback signaling including the CQI and PCI.

“HSPA Evolved” or HSPA+is an evolution of the HSPA standard that includes MIMO and 64-QAM, enabling increased throughput and higher performance. That is, in an aspect of the disclosure, the node B 708 and/or the UE 710 may have multiple antennas supporting MIMO technology. The use of MIMO technology enables the node B 708 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 710 to increase the data rate or to multiple UEs 710 to increase the overall system capacity. This is achieved by spatially precoding each data stream and then transmitting each spatially precoded stream through a different transmit antenna on the downlink. The spatially precoded data streams arrive at the UE(s) 710 with different spatial signatures, which enables each of the UE(s) 710 to recover the one or more the data streams destined for that UE 710. On the uplink, each UE 710 may transmit one or more spatially precoded data streams, which enables the node B 708 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

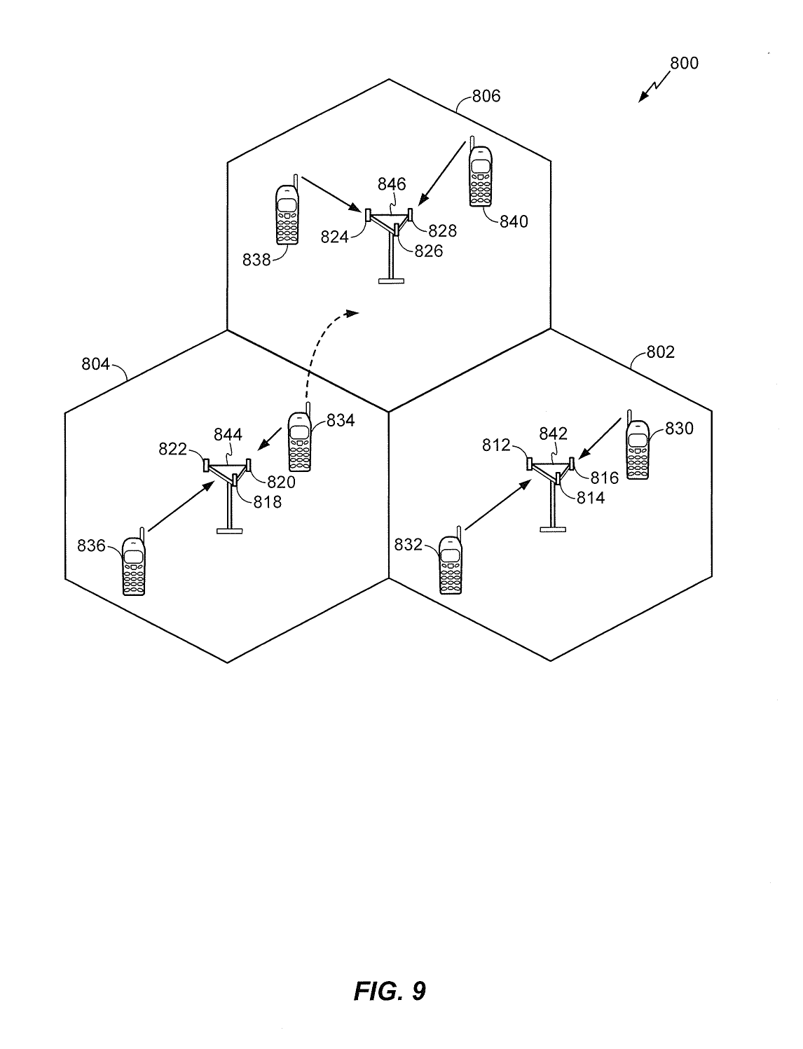

Referring to FIG. 9, an access network 800 in a UTRAN architecture is illustrated.

The multiple access wireless communication system includes multiple cellular regions (cells), including cells 802, 804, and 806, each of which may include one or more sectors. The multiple sectors can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector. The cells 802, 804 and 806 may include several wireless communication devices, e.g., User Equipment or UEs, which may be in communication with one or more sectors of each cell 802, 804 or 806. For example, UEs 830 and 832 may be in communication with Node B 842, UEs 834 and 836 may be in communication with Node B 844, and UEs 838 and 840 can be in communication with Node B 846. Here, each Node B 842, 844, 846 is configured to provide an access point to a core network 704 (see FIG. 8) for all the UEs 830, 832, 834, 836, 838, 840 in the respective cells 802, 804, and 806. Node Bs 842, 844, and 846 may correspond to network entity 12 (FIG. 1), which may include local proxy 20 which may be configured to execute proxy component 30.

As the UE 834 moves from the illustrated location in cell 804 into cell 806, a serving cell change (SCC) or handover may occur in which communication with the UE 834 transitions from the cell 804, which may be referred to as the source cell, to cell 806, which may be referred to as the target cell. Management of the handover procedure may take place at the UE 834, at the Node Bs corresponding to the respective cells, at a radio network controller 706 (see FIG. 8), or at another suitable node in the wireless network. For example, during a call with the source cell 804, or at any other time, the UE 834 may monitor various parameters of the source cell 804 as well as various parameters of neighboring cells such as cells 806 and 802. Further, depending on the quality of these parameters, the UE 834 may maintain communication with one or more of the neighboring cells. During this time, the UE 834 may maintain an Active Set, that is, a list of cells that the UE 834 is simultaneously connected to (i.e., the UTRA cells that are currently assigning a downlink dedicated physical channel DPCH or fractional downlink dedicated physical channel F-DPCH to the UE 834 may constitute the Active Set).

The modulation and multiple access scheme employed by the access network 800 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

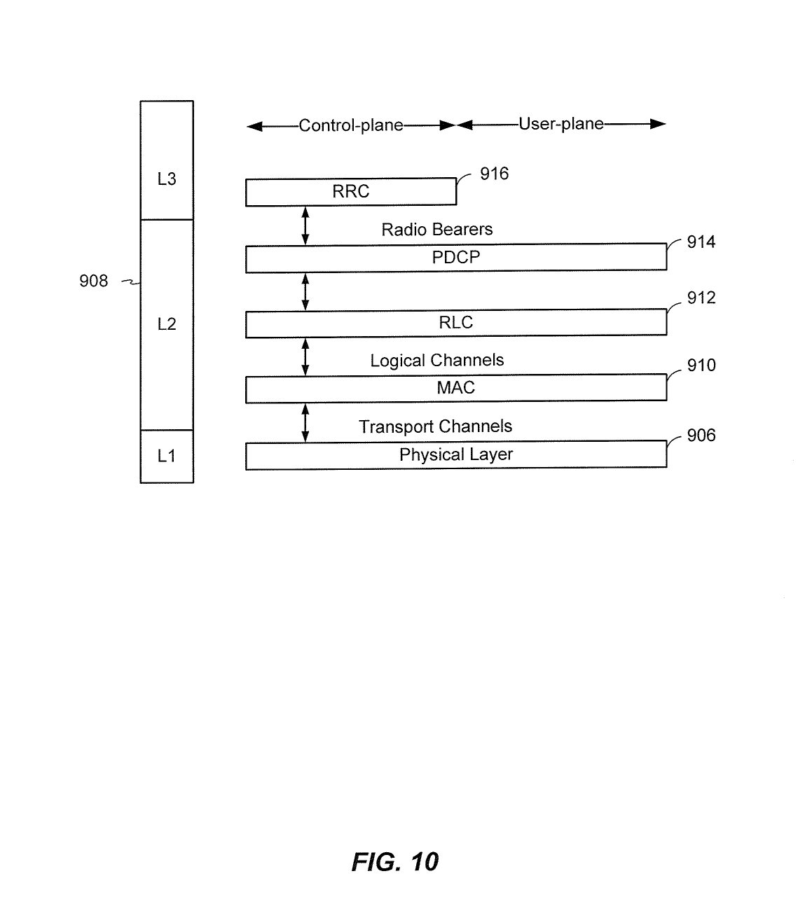

The radio protocol architecture may take on various forms depending on the particular application. An example for an HSPA system will now be presented with reference to FIG. 10.

Referring to FIG. 10, an example of the radio protocol architecture 900 for the user plane 902 and the control plane 904 may be included in a network entity and/or UE such as an entity within network 112 and/or UE 114 (FIG. 1). The radio protocol architecture 900 for the UE and node B is shown with three layers: Layer 1 906, Layer 2 908, and Layer 3 910. Layer 1 906 is the lowest lower and implements various physical layer signal processing functions. As such, Layer 1 906 includes the physical layer 907. Layer 2 (L2 layer) 908 is above the physical layer 907 and is responsible for the link between the UE and node B over the physical layer 907. Layer 3 (L3 layer) 910 includes a radio resource control (RRC) sublayer 915. The RRC sublayer 915 handles the control plane signaling of Layer 3 between the UE and the UTRAN.

In the user plane, the L2 layer 908 includes a media access control (MAC) sublayer 909, a radio link control (RLC) sublayer 911, and a packet data convergence protocol (PDCP) 913 sublayer, which are terminated at the node B on the network side. Although not shown, the UE may have several upper layers above the L2 layer 908 including a network layer (e.g., IP layer) that is terminated at a PDN gateway on the network side, and an application layer that is terminated at the other end of the connection (e.g., far end UE, server, etc.).

The PDCP sublayer 913 provides multiplexing between different radio bearers and logical channels. The PDCP sublayer 913 also provides header compression for upper layer data packets to reduce radio transmission overhead, security by ciphering the data packets, and handover support for UEs between node Bs. The RLC sublayer 911 provides segmentation and reassembly of upper layer data packets, retransmission of lost data packets, and reordering of data packets to compensate for out-of-order reception due to hybrid automatic repeat request (HARQ). The MAC sublayer 909 provides multiplexing between logical and transport channels. The MAC sublayer 909 is also responsible for allocating the various radio resources (e.g., resource blocks) in one cell among the UEs. The MAC sublayer 909 is also responsible for HARQ operations.

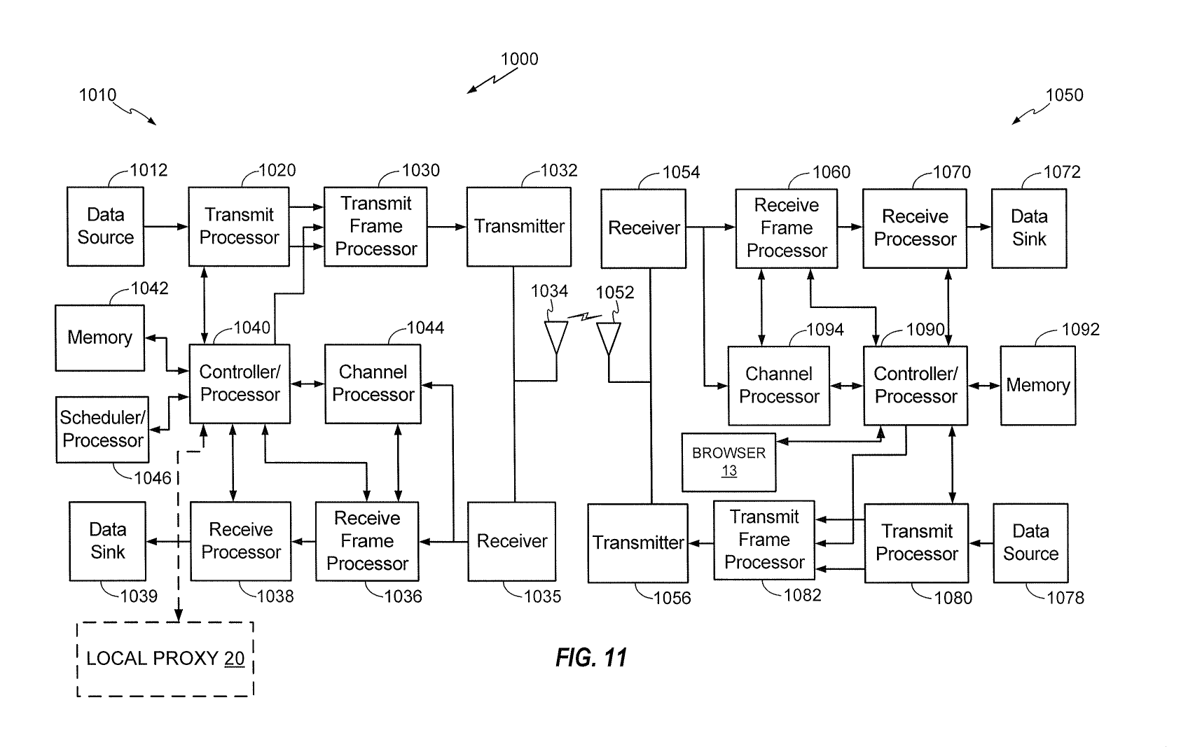

FIG. 11 is a block diagram of a Node B 1010 in communication with a UE 1050, where the Node B 1010 may be the Node B 14 in FIG. 1, and the UE 1050 may be the UE 11 in FIG. 1. In the downlink communication, a transmit processor 1020 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the Node B 1010. More specifically, the receive processor 1070 descrambles and despreads the symbols, and then determines the most likely signal constellation points transmitted by the Node B 1010 based on the modulation scheme. These soft decisions may be based on channel estimates computed by the channel processor 1094. The soft decisions are then decoded and deinterleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receiver processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the Node B 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the Node B 1010 or from feedback contained in the midamble transmitted by the Node B 1010, may be used to select the appropriate coding, modulation, spreading, and/or scrambling schemes. The symbols produced by the transmit processor 1080 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the Node B 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the

Node B 1010 and the UE 1050, respectively. For example, the controller/processors 1040 and 1090 may provide various functions including timing, peripheral interfaces, voltage regulation, power management, and other control functions. The computer readable media of memories 1042 and 1092 may store data and software for the Node B 1010 and the UE 1050, respectively. A scheduler/processor 1046 at the Node B 1010 may be used to allocate resources to the UEs and schedule downlink and/or uplink transmissions for the UEs.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, or 35 U.S.C. §112(f), unless the element is expressly recited using the phrase “means for” or, in the case of a method claim, the element is recited using the phrase “step for.”

What is claimed is:

1. A method for reducing round-trip time (RRT) for communications between a proxy and a browser, comprising:
receiving a webpage from a server in response to forwarding to the server a first request received from the browser;
parsing the webpage for one or more object identifiers;
requesting one or more objects from the server based on the one or more object identifiers; and
storing the one or more objects received from the server.

2. The method of claim 1, further comprising:
receiving a second request from the browser for an object; and
determining whether the object was previously requested from the server prior to receiving the second request from the browser.

3. The method of claim 2, further comprising:
forwarding the second request to the server based on the determination that the object was not previously requested;
receiving a response including the object from the server in response to the second request; and
transmitting the object received from the server to the browser.

4. The method of claim 3, wherein the second request for the object includes an indication set to a high priority, and wherein the second request with the indication set to the high priority is transmitted to the server before a request with an indication set to a low priority.

5. The method of claim 3, wherein the response received from the server includes an indication set to at least one of a high priority and a low priority, and wherein the indication is determined based on whether the object was requested by the browser.

6. The method of claim 5, wherein the high priority corresponds to the object being requested by the browser, and wherein the low priority corresponds to the object being requested by the proxy.

7. The method of claim 2, further comprising:
determining that the object was received from the server when a determination is made that the object was previously requested; and
transmitting the object to the browser in response to determining that the object was received from the server.

8. The method of claim 1, wherein the request for the one or more objects from the server includes an indication set to a low priority, and wherein the request with the indication set to the low priority is transmitted to the server after a request with an indication set to a high priority.

9. The method of claim 1, wherein the one or more objects correspond to one or more hypertext transfer protocol (HTTP) objects.

10. The method of claim 9, further comprising:
identifying the first request from the browser as HTTP traffic;
recording a transaction identification (ID) located in a header of the first request; and
requesting the webpage from the server in response to recording the transaction ID.

11. An apparatus for reducing round-trip time (RRT) for communications between a proxy and a browser, comprising:
means for receiving a webpage from a server in response to forwarding to the server a first request received from the browser;
means for parsing the webpage for one or more object identifiers;
means for requesting one or more objects from the server based on the one or more object identifiers; and
means for storing the one or more objects received from the server.

12. An apparatus for reducing round-trip time (RRT) for communications between a proxy and a browser, comprising:
a receiving component configured to receive a webpage from a server in response to forwarding to the server a first request received from the browser;
a parsing component configured to parse the webpage for one or more object identifiers;
a requesting component configured to request one or more objects from the server based on the one or more object identifiers; and
a storing component configured to store the one or more objects received from the server.

13. The apparatus of claim 12, wherein the receiving component is further configured to receive a second request from the browser for an object; and
a determining component configured to determine whether the object was previously requested from the server prior to receiving the second request from the browser.

14. The apparatus of claim 13, wherein the requesting component is further configured to forward the second request to the server based on the determination that the object was not previously requested;
wherein the receiving component is further configured to receive a response including the object from the server in response to the second request; and
a transmitting component configured to transmit the object received from the server to the browser.

15. The apparatus of claim 14, wherein the second request for the object includes an indication set to a high priority, and wherein the second request with the indication set to the high priority is transmitted to the server before a request with an indication set to a low priority.

16. The apparatus of claim 14, wherein the response received from the server includes an indication set to at least one of a high priority and a low priority, and wherein the indication is determined based on whether the object was requested by the browser.

17. The apparatus of claim 16, wherein the high priority corresponds to the object being requested by the browser, and wherein the low priority corresponds to the object being requested by the proxy.

18. The apparatus of claim 13, wherein the determining component is further configured to determine that the object was received from the server when a determination is made that the object was previously requested; and
wherein the transmitting component is further configured to transmit the object to the browser in response to determining that the object was received from the server.

19. The apparatus of claim 12, wherein the request for the one or more objects includes an indication set to a low priority, and wherein the request with the indication set to the low priority is transmitted to the server after a request with an indication set to a high priority.

20. The apparatus of claim 12, wherein the one or more objects correspond to one or more hypertext transfer protocol (HTTP) objects.

21. The apparatus of claim 20, wherein the receiving component is further configured to identify the first request from the browser as HTTP traffic;
wherein the storing component is further configured to record a transaction identification (ID) located in a header of the first request; and
wherein the requesting component is further configured to request the webpage from the server in response to recording the transaction ID.

22. A computer-readable medium storing computer executable code for reducing round-trip time (RRT) for communications between a proxy and a browser, comprising:
code for receiving a webpage from a server in response to forwarding to the server a first request received from the browser;
code for parsing the webpage for one or more object identifiers;
code for requesting one or more objects from the server based on the one or more object identifiers; and
code for storing the one or more objects received from the server.
